(19) United States
(12) Patent Application Publication
(10) Pub. No.: US 2013/0137001 A1
(43) Pub. Date: May 30, 2013

(54) NON-AQUEOUS ELECTROLYTE SOLUTIONS AND LITHIUM/OXYGEN BATTERIES USING THE SAME

(71) Applicants: Shengshui Zhang, Olney, MD (US); Donald L. Foster, Laurel, MD (US); Jeffrey A. Read, West Friendship, MD (US)

(72) Inventors: Shengshui Zhang, Olney, MD (US); Donald L. Foster, Laurel, MD (US); Jeffrey A. Read, West Friendship, MD (US)

(73) Assignee: U.S Government as represented by the Secretary of the Army, Adelphi, MD (US)

(21) Appl. No.: 13/304,784

(22) Filed: Nov. 28, 2011

(51) Int. Cl. H01M 10/056; H01M 8/22

(52) U.S. Cl. 429/405; 429/330; 429/329; 429/328; 429/327; 429/326; 429/333; 429/332

(57) ABSTRACT

A lithium/oxygen battery includes a lithium anode, an air cathode, and a non-aqueous electrolyte soaked in a microporous separator membrane, wherein non-aqueous electrolyte comprises a lithium salt with a general molecular formula of LiBF₃X (X═F, Cl, or Br, respectively) and a non-aqueous solvent mixture.

### REFERENCE TO ISSUED PATENTS

Attention is directed to commonly owned and assigned U.S. Pat. No. 7,147,967, issued Dec. 12, 2006, entitled “CATHODE FOR METAL-OXYGEN BATTERY”, wherein there is disclosed a cathode material for a metal-oxygen battery such as a lithium-oxygen battery. The material comprises, on a weight basis, a first component which is an oxide or a sulfide of a metal. The first component is capable of intercalating lithium, and is present in an amount of greater than about 20 percent and to about 80 percent of the material. The material includes a second component which comprises carbon. The carbon is an electro active catalyst which is capable of reducing oxygen, and comprises from about 10 to about 80 percent of the material. The material further includes a binder, such as a fluoropolymer binder, which is present in an amount of from about 5 to about 40 weight percent.

U.S. Pat. No. 7,147,967, issued Dec. 12, 2006, entitled “FLUOROHALOBORATE SALTS, SYNTHESIS AND USE THEREOF”, wherein there is disclosed a composition as a salt having the formula MBF₃X where M is an alkali metal cation and X is the halide fluoride, chloride, bromide or iodide. A lithium salt has several characteristics making the composition well suited for inclusion within a lithium-ion battery. A process tier forming an alkali metal trifluorohaloborate salt includes the preparation of a boron trifluoride etherate in an organic solvent. An alkali metal halide salt where the halide is fluoride, chloride, bromide or iodide is suspended in the solution and reacted with boron trifluoride etherate to form an alkali metal trifluorohaloborate. The alkali metal trifluorohaloborate so produced is collected as a solid from the solution.

The entire disclosures of each of the above mentioned patents are incorporated herein by reference in their entirety. The appropriate components and processes of these patents may be selected for the electrolyte and processes of the present invention in embodiments thereof.

### BACKGROUND

In aspects, the instant application relates generally to electrochemical cells. The present invention relates to a non-aqueous lithium/oxygen battery, especially a non-aqueous electrolyte solution that benefits the performance of such batteries. An exemplary embodiment of the instant invention is a non-aqueous lithium/oxygen cell comprising a lithium anode, a carbon air cathode, and a non-aqueous electrolyte soaked in a microporous separator membrane.

Metal-oxygen batteries, which are also referred to as metal-air batteries, are a class of electrochemical cells in which oxygen, which is typically obtained from the ambient environment, is reduced at a catalytic cathode surface as part of the electrochemical cell reaction.

Theoretically, the operation of a lithium/air battery can last as long as the supply of oxygen from environmental air and metal lithium remain. However, in embodiments, the operation of a practical lithium—air battery is often halted by the insoluble oxygen reduction products lithium peroxide (Li₂O₂) and lithium oxide (Li₂O) that deposit and accumulate on the surface of the carbon air cathode and eventually clog the porous channels used for the diffusion of gaseous oxygen.

Reduction of the oxygen forms an oxide or peroxide ion which reacts with a cationic metal species. Metal-oxygen batteries have been developed based upon iron (Fe), zinc (Zn), aluminum (Al), magnesium (Mg), calcium (Ca), and lithium.

Typically, metal/air batteries contain a metal anode, an air cathode, and a liquid electrolyte that provide a media for ionic conduction and electronically isolates the anode and air cathode. The air cathodes may, for example, comprise a highly porous carbon sheet with or without catalyst-loading. Among many metals suitable for the anode of metal/air batteries, lithium is attractive because of its low molecular weight and its negative electrode potential that offer high energy and power densities.

However, metal lithium requires a dry environment and a non-aqueous organic electrolyte to avoid reaction with moisture. Lithium/air batteries are different from other conventional metal/air batteries in that their discharge products (Li₂O₂) and lithium oxide (Li₂O) are insoluble in organic electrolytes. Lithium-oxygen batteries represent one type of metal-oxygen battery. In devices of this type, an electro-active cathode and a lithium-containing anode are disposed in an electrolyte which provides for ionic communication. During the discharge of the cell, oxygen is reduced at the electro-active cathode to produce O₂⁻¹ and/or O₂⁻² anions which combine with the lithium ions to produce Li₂O₂ and/or Li₂O which deposits on the cathode. Therefore, the oxides (Li₂O₂ and Li₂O) are deposited on the surfaces of the carbon cathode, rather than dissolved into the electrolyte, which prevents oxygen from diffusing into the reaction sites of the carbon. The battery fails to function when the surfaces of the carbon are fully covered by the discharge products.

Therefore, specific capacities of lithium/air batteries are determined by the amount of the oxides that form on the surfaces of the carbon in the air cathode.

In lithium/air batteries, oxygen is catalytically reduced to form peroxide anions on the surfaces of carbon (serving as a catalyst), and the resulting peroxide anions combine with Li⁺ ions from the electrolyte to form lithium peroxides (Li₂O₂) that deposit on the surfaces of the carbon. Depending on the discharge current rates and electrolyte formulations, the deposited lithium peroxides can be further discharged to lithium oxide (Li₂O). Theoretically, lithium/air batteries have a specific capacity of 3862 mAh/g Li and specific energy densities of 11,425 Wh/kg and 11,248 Wh/kg, based on their discharge products lithium peroxide and lithium oxide, respectively.

High polarization of lithium/oxygen batteries is due to slow catalytic reduction of oxygen, which is affected by two factors: (1) the kinetics of the catalytic reduction of oxygen and (2) diffusion of dissolved oxygen in the liquid electrolyte. The former can be enhanced by using a catalyst and modifying the electrolyte formulation. The latter can be improved by reducing the viscosity of the liquid electrolytes and minimizing the diffusion distance of the dissolved oxygen, which can be achieved by adopting low viscous electrolyte solvents and avoiding electrolyte-flooding. Power and energy densities of practical lithium/oxygen batteries are not close to the theoretical expectations. Therefore, there remains a need to develop better electrolytes for improvement of the performance of lithium/oxygen batteries.

### SUMMARY

A non-aqueous electrolyte solution comprising a salt having the formula MBF₃X where M is an alkali metal cation or a quaternary organic ammonium cation; and X is the halide chloride, bromide or iodide and a solvent mixture consisting of a first solvent and a second solvent. A non-aqueous electrolyte solution and lithium salt have several characteristics making it well suited for inclusion within a lithium-ion battery.

Also provided is non-aqueous electrolyte lithium/oxygen battery that has a high discharge voltage when compared to the same lithium/oxygen battery using conventional or prior art electrolytes.

In one aspect, the present invention provides a non-aqueous electrolyte lithium/oxygen battery that has a higher discharge voltage than the prior art. The battery comprises a lithium anode, an air (oxygen) cathode, and a non-aqueous organic electrolyte soaked in a microporous separator membrane.

A key aspect of the present invention is a non-aqueous electrolyte solution that comprises a lithium salt with a general molecular formula of LiBF₃X wherein X is fluorine, chlorine, iodine or bromine, respectively, and a solvent mixture consisting of a first solvent and a second solvent. The first solvent has a higher boiling point than the second solvent and a relatively high viscosity of from greater than about 1.5 centipoises at twenty-live (25) degrees Celsius. The first solvent may, for example, comprise ethylene carbonate (EC), propylene carbonate (PC), gamma-butyrlactone (GBL), N-methylpyrrolidinone (NMP), tetramethylene sulfone (sulfolane), triethylene glycol dimethyl ether, tetraethylene glycol dimethyl ether, and mixtures thereof. The second solvent has lower boiling point and low viscosity, which is selected from the group of cyclic ethers, linear ethers having a molecular formula of CₘH₂ₘ₊₁OCₙH₂ₙ₊₁ wherein m and n are independently from 1 to 4, linear carbonates having a molecular formula of CₓH₂ₓ₊₁OC(O)OC_{y}H_{2y+1} wherein x and y are independently from 1 to 4, and mixtures thereof. Concentrations of lithium salt in the electrolytes are from about 0.1 molal (m) to about 1.5 molal (m), and ratio of the first solvent in the solvent mixtures is from about 10 percent to about 90 percent by volume. Alternatively, said non-aqueous electrolyte may be plasticized into a polymer to form a gel polymer electrolyte.

In accordance with embodiments of the present invention, the air cathode is comprised of a highly porous carbon sheet that is made by bonding carbon powder with high specific surface areas with a polymer binder. Alternatively, additional catalyst material can be added into the air cathode either by coating it onto the surfaces of carbon or by mixing it with a conductive carbon powder. Polymer binders are these commonly used in the cathode of lithium batteries and lithium-ion batteries, which may, for example comprise polyvinylidene fluoride (PVdF), hexafluoropropylene-vinylidene fluoride copolymers (PVdF-HFP), and polytetrafluoroethylene (PTFE). Separators are microporous polyolefin membranes or non-woven clothes made of synthetic polymer resins.

The inventive composition has the attribute of forming X₂, wherein X comprises fluorine, chlorine, or bromine, upon exposure to oxygen. Within a lithium-ion battery oxygen is released during overcharge. This inventive attribute has the advantage of protecting a non-aqueous electrolyte battery from cathodic overcharge exotherms.

Various objects, features, aspects and advantages of the present invention will become more apparent from the following detailed description of the embodiments of the invention.

### BRIEF DESCRIPTION OF THE DRAWINGS

FIG. 1 is a graph indicating the effect of salt concentration on discharge performance of exemplary lithium/oxygen cells for a LiBF₄ dissolved in a 3:7 (wt. %) ethylene carbonate (EC)/dimethyl ether (DME) solvent mixture according to the invention subject matter.

FIG. 2 is a graph indicating discharge performance of exemplary lithium/oxygen cells for a 1.0 m Li salt dissolved in a 3:7 (wt. %) EC/DME solvent mixture according to the invention subject matter.

FIG. 3 is a graph indicating the effect of the solvent composition on the discharge performance of exemplary lithium/oxygen cells according to the invention subject matter.

### DETAILED DESCRIPTION

In accordance with the present invention, the lithium/oxygen cell is composed of a lithium anode, an air (oxygen) cathode, and a non-aqueous organic electrolyte soaked in a microporous separator membrane. The air cathode is a highly porous carbon sheet that is made by bonding a conductive carbon powder with high specific surface areas together with a polymer binder, wherein carbon not only is a conducting agent, but also serves as a catalyst for the catalytic reduction of oxygen. Alternatively, additional catalyst can be added into the air cathode by coating it onto the surfaces of carbon or by mixing it with carbon powder. Suitable catalysts comprise, for example, metal macrocycles such as cobalt phthalocyanine, iron phthalocyanine, other phthalocyanines for example manganese, copper, transition metal oxides such as MnO₂, FeOₓ, CoO, NiO, silver (Ag), carbon-supported platinum, carbon-supported gold, and carbon-supported palladium and highly dispersed precious metals such as platinum/ruthenium alloys. Polymer binders used in the cathode of lithium batteries and lithium-ion batteries may comprise polyvinylidene fluoride (PVdF), hexafluoropropylene-vinylidene fluoride copolymers (PVdF-HFP), and polytetrafluoroethylene (PTFE).

To avoid electrical circuit-shorting, a separator is placed between the lithium anode and the air cathode, and non-aqueous liquid electrolytes are soaked into the pores of the separators to supply ionic conduction. Separators may, for example, be a microporous membrane of polypropylene and polyethylene, a non-woven cloth of synthetic polymer resin such as polytetrafluoroethylene, polypropylene, or a woven porous body of such materials.

With respect to the electrolyte, it comprises a non-aqueous organic solution that comprises a lithium salt and a solvent mixture. In accordance with the present invention, the lithium salt has a general chemical formula of LiBF₃X wherein X is fluorine, chlorine or bromine, respectively. Concentrations of lithium salt in the electrolytes range from about 0.1 m to about 1.5 m. The electrolyte solvent comprises a mixture consisting of a first solvent and a second solvent. The first solvent has high dielectric constant of greater than about thirty (30) and a high boiling point (i.e., low volatility) of about 200 degrees Celsius, and which may, for example, comprise ethylene carbonate (EC), propylene carbonate (PC), gamma-butyrlactone (GBL), N-methyl pyrrolidinone (NMP), tetramethylene sulfone, triethylene glycol dimethyl ether, tetraethylene glycol dimethyl ether, and mixtures thereof. In general, these solvents are very viscous, for example, greater than 1.5 centipoises at about twenty-five (25) degrees Celsius. Non-aqueous electrolytes used in the-state-of-the-art lithium-ion batteries contain a solvent system that, in general, includes a cyclic carbonate compound, such as ethylene carbonate (EC) and propylene carbonate (PC), as well as a linear carbonate, such as dimethyl carbonate (DMC), diethyl carbonate (DEC), and ethylmethyl carbonate (EMC). The cyclic carbonates are chemically and physically stable and have high dielectric constant, which is necessary for their ability to dissolve salts. The linear carbonates are also chemically and physically stable and have low dielectric constant and low viscosity, which is necessary to increase the mobility of the lithium ions in the electrolytes. “PC-based electrolyte system” contains PC as one of the components and, when the only cyclic carbonate present is EC, the electrolyte system is considered “EC-based”.

Therefore, a second solvent with low viscosity for example of less than about 0.8 centipoises at about twenty-five (25) degrees Celsius is added to reduce the viscosity of the solvent mixture. The second solvent generally has a lower boiling point (high volatility) for example, a boiling point of less than about ninety (90) degrees Celsius and a relatively low dielectric constant for example, a dielectric constant of less than ten (10) which may further comprise cyclic ethers, linear ethers having a molecular formula of CₘH₂ₘ₊₁OCₙH₂ₙ₊₁ wherein m and n are independently from 1 to 4, linear carbonates having a molecular formula of CₓH₂ₓ₊₁OC(O)OC_{y}H_{2y+1} wherein x and y are independently from 1 to 4, and mixtures thereof. Examples of cyclic ethers may comprise, for example, 1,3-dioxolane, methyldioxolane, tetrahydrofuran, 2-methyltetrahydrofuran, 4-tetrahydropyran. Examples of linear ethers include 1,2-dimethoxyethane (DME),1,2-diethoxyethane, and 1-methoxy-2-ethyoxyethane. Examples of linear carbonates include dimethyl carbonate (DMC), ethyl methyl carbonate (EMC), diethyl carbonate (DEC), dipropyl carbonate, methyl propyl carbonate, ethyl propyl carbonate. In accordance with the present invention, the ratio of the first solvent in the solvent mixtures is ranged from 10 percent to 90 percent by volume.

In yet further contemplated aspects of the invention subject matter, said non-aqueous electrolyte solution may be plasticized into a polymer to form gel polymer electrolyte. Suitable polymers are selected from the group of poly(ethylene oxide) (PEO), polyvinylidene fluoride (PVdF), hexafluoropropylene-vinylidene fluoride copolymers (PVdF-HFP), poly(methyl methacrylate) (PMMA), polyvinyl acetate (PVAC), Polyvinyl chloride (PVC), and polyacrylonitrile (PAN).

### EXAMPLES

The following examples provide details illustrating advantageous properties and performance of lithium/oxygen batteries using a non-aqueous organic electrolyte in accordance with the present invention. These examples are provided to exemplify and more clearly illustrate aspects and embodiments of the present invention and are in no way intended to be limiting.

Air cathodes were prepared by using an activated carbon as the active material and a polytetrafluoroethylene emulsion (PTFE), solid content from about 61.5 percent. An air cathode with a composition of 98 percent activated carbon and 2 percent polytetrafluoroethylene by weight was fabricated as follows: weighed carbon was wetted with an appropriate amount of 98 percent ethanol, and then a calculated amount of polytetrafluoroethylene emulsion was added and mixed to form a uniform paste, followed by drying in an 80 degrees Celsius (° C.) oven. When most of the solvent was evaporated, the warm paste was rolled into a self-standing thin sheet. The resulting carbon sheet was punched into small discs with a diameter of 7/16 inch (equal to 0.97 cm²) and dried at 110 degrees Celsius (° C.) under vacuum for 8 hours. In embodiments the air cathode had a thickness range of from about 0.56 to about 0.63 mm, an activated carbon loading of from about 18.0 to about 19.0 mg/cm², and a porosity of from about 2.9 to about 3.2 mL/g (vs. carbon). A series of electrolyte solutions with different formulations was prepared in a dry-room having a dew point of about 90 degrees Celsius (° C.) for performance comparison of lithium/oxygen cells.

Lithium/oxygen testing cells with a cathode-limited design were assembled as follows: in the dry-room, a lithium foil (⅝ inch diameter), a membrane (¾ inch diameter), an air (carbon) cathode made above ( 7/16 inch diameter), and a nickel mesh (⅝ inch diameter) with a nickel tab as the cathode current lead were in sequence laminated into a button cell cap (24 mm diameter), then a silicon rubber disc (having a 22 mm diameter and a 3 mm thickness) with a 7/16 inch diameter hollow as the oxygen window was placed on the top of the nickel mesh to obtain a dry cell stack. To activate the cell stack with electrolyte, 200 uL of liquid electrolyte was added through the air-window, and vacuum was applied to ensure complete wetting. Extra liquid electrolyte was removed by lightly pressing a filter paper on the nickel mesh. The electrolyte-activated cell was clamped in a button cell holder to maintain constant pressure, sealed in a foil laminate pouch, and finally filled with pure oxygen.

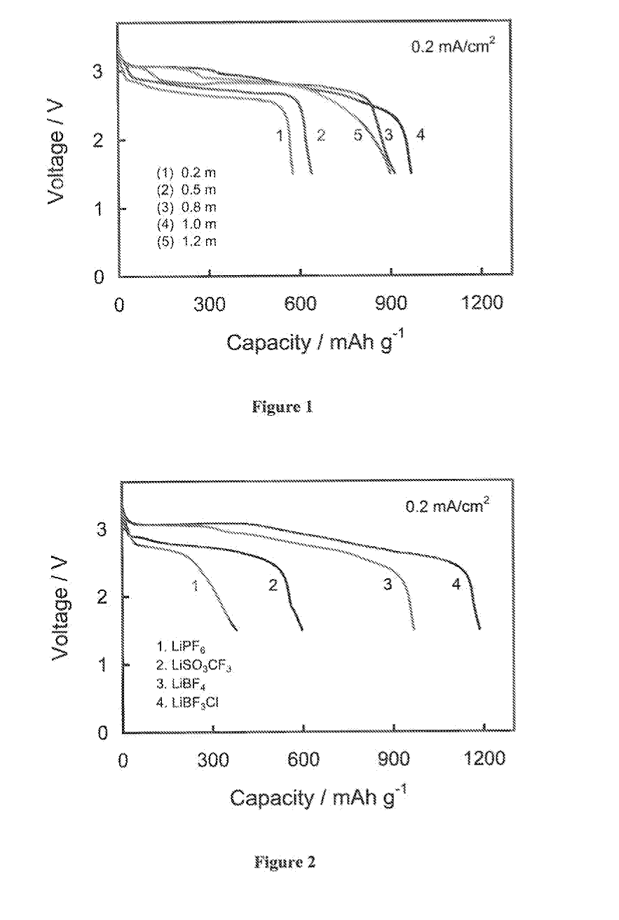

Lithium/oxygen cells were discharged at 0.2 mA/cm² on a cycler with a 1.5 V cutoff voltage. FIG. 1 shows the discharge performance of five lithium/oxygen cells with electrolytes prepared by dissolving different concentrations of LiBF₄ in a 3:7 (wt.) ethyl carbonate/dimethyl ether (EC/DME) solvent mature. It is obvious that the cells with electrolytes having LiBF₄ concentrations of more than 0.8 m show higher discharge voltages and higher capacities than those battery cells with from about 0.2 molal to about 0.5 molal LiBF₄ electrolytes. Especially for the cells with from about 1.0 m to about 1.2 LiBF₄ electrolytes, their discharge voltages in the first plateau (i.e., in initial 300 mAh/g) are almost equal to the theoretical open-circuit voltage of reaction “O₂+Li→Li₂O₂”.

FIG. 2 shows discharge performance of four lithium/oxygen cells, in which all four cells used an electrolyte consisting of about 1.0 molal lithium salt and a 3:7 (wt. %) ethyl carbonate/dimethyl ether (EC/DME) solvent mixture. Results indicate that the cells using LiBF₄ and LiBF₃Cl electrolytes have significant advantages over the other two with LiPF₆ and LiSO₃CF₃ salts despite the fact that all other conditions including salt concentration and solvent composition remain the same.

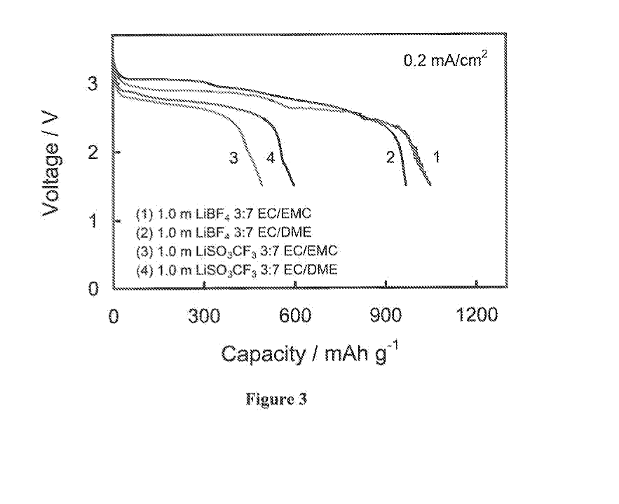

FIG. 3 shows discharge performance of four lithium/oxygen cells with different electrolyte formulations, which indicates LiBF₄ electrolytes have significant advantages over the LiSO₃CF₃ counterparts in both discharge voltages and capacities. FIG. 3 also indicates that discharge performances of lithium/oxygen cells are affected by the composition of solvent mixtures.

What is claimed is:

1. A non-aqueous electrolyte solution comprising a lithium salt with a general molecular formula of LiBF₃X where X is selected from the group consisting of fluorine, chlorine, bromine, or iodine, and a solvent mixture comprised of:
(a) a first solvent and a second solvent;
(b) wherein said first solvent comprises ethylene carbonate, propylene carbonate, gamma-butyrlactone, N-methylpyrrolidinone, tetramethylene sulfone, triethylene glycol dimethyl ether, tetraethylene glycol, dimethyl ether, and mixtures thereof.
(c) further wherein said first solvent has a dielectric constant of greater than about thirty (30), a boiling point of greater than about two hundred (200) degrees Celsius, and a viscosity of greater than about 1.5 centipoises at about twenty-five (25) degrees Celsius;
(d) wherein said second solvent comprises cyclic ethers, linear ethers having a molecular formula of CₘH₂ₘ₊₁OCₙH₂ₙ₊₁ wherein m and n are independently from 1 to 4, linear carbonates having a molecular formula of CₓH₂ₓ₊₁OC(O)OC_{y}H_{2y+1} wherein x and y are independently from 1 to 4, and mixtures thereof;
(e) further wherein said second solvent has viscosity of less than about 0.8 centipoises at twenty-five (25) degrees Celsius, a boiling point of less than about ninety (90) degrees Celsius, and a dielectric constant of less than about ten (10);
(f) wherein the ratio of the first solvent in said solvent mixture varies from about 10 percent to about 90 percent by volume;
(g) wherein the ratio of the second solvent in said solvent mixture varies from about 10 percent to about 90 percent by volume; and
(h) wherein the concentration of said lithium salt is from about 0.1 molal to about 1.5 molal.

2. The lithium salt according to claim 1 wherein X is fluorine.

3. The lithium salt according to claim 1 wherein X is chlorine.

4. The lithium salt according to claim 1 wherein X is bromine.

5. The lithium salt according to claim 1 wherein X is iodine.

6. A metal/oxygen battery comprising:
(a) a lithium anode;
(b) an air cathode;
(c) a non-aqueous electrolyte solution according to claim 1; and
(d) a microporous separator placed between said lithium anode and said air cathode.

7. A non-aqueous electrolyte solution according to
(a) wherein said first solvent is comprised of an ethylene carbonate and dimethyl ether mixture having a dielectric constant of greater than about thirty (30), a boiling point of greater than about two hundred (200) degrees Celsius, and a viscosity of greater than about 1.5 centipoises at about twenty-five (25) degrees Celsius;
(b) wherein said second solvent is comprised of cyclic ethers, linear ethers having a molecular formula of CₘH₂ₘ₊₁OCₙH₂ₙ₊₁ wherein m and n are independently from 1 to 4;
(c) further wherein said second solvent has viscosity of less than about 0.8 centipoises at about twenty-five (25) degrees Celsius, a boiling point of less than about ninety (90) degrees Celsius, and a dielectric constant of less than about ten (10);
(d) wherein the ratio of the first solvent in said solvent mixture varies from about 10 percent to about 90 percent by volume;
(e) wherein the ratio of the second solvent in said solvent mixture varies from about 10 percent to about 90 percent by volume;
(f) wherein the concentration of said lithium salt is from about 0.1 molal to about 1.5 molal; and
(g) wherein the lithium salt is fluorine.

8. A non-aqueous electrolyte solution according to claim 1:
(a) wherein said first solvent is comprised of an ethylene carbonate and dimethyl ether mixture having a dielectric constant of greater than about thirty (30), a boiling point of greater than about two hundred (200) degrees Celsius, and a viscosity of greater than about 1.5 centipoises at about twenty-five (25) degrees Celsius;
(b) wherein said second solvent is comprised of linear carbonates having a molecular formula of CₓH₂ₓ₊₁OC(O)OC_{y}H_{2y+1} wherein x and y are independently from 1 to 4;
(c) further wherein said second solvent has viscosity of less than about 0.8 centipoises at twenty-five (25) degrees Celsius, a boiling point of less than about ninety (90) degrees Celsius, and a dielectric constant of less than about ten (10);
(d) wherein the ratio of the first solvent in said solvent mixture varies from about 10 percent to about 90 percent by volume;
(e) wherein the ratio of the second solvent in said solvent mixture varies from about 10 percent to about-90 percent by volume;
(f) wherein the concentration of said lithium salt is from about 0.1 molal to about 1.5 molal; and
(g) wherein the lithium salt is chlorine.

9. A non-aqueous electrolyte solution according to claim 1:
(a) wherein said first solvent is comprised of an ethylene carbonate and dimethyl ether mixture having a dielectric constant of greater than about thirty (30), a boiling point of greater than about two hundred (200) degrees Celsius, and a viscosity of greater than about 1.5 centipoises;
(b) wherein said second solvent is comprised of cyclic ethers, linear ethers having a molecular formula of CₘH₂ₘ₊₁OCₙH₂ₙ₊₁ wherein m and n are independently from 1 to 4, linear carbonates having a molecular formula of CₓH₂ₓ₊₁OC(O)OC_{y}H_{2y+1} wherein x and y are independently from 1 to 4, and mixtures thereof;
(c) further wherein said second solvent has viscosity of less than about 0.8 centipoises at twenty-five (25) degrees Celsius, a boiling point of less than about ninety (90) degrees Celsius, and a dielectric constant of less than about ten (10);
(c) wherein the ratio of the first solvent in said solvent mixture varies from about 10 percent to about 90 percent by volume;
(d) wherein the ratio of the second solvent in said solvent mixture varies from about 10 percent to about 90 percent by volume;
(e) wherein the concentration of said lithium salt is from about 0.1 molal to about 1.5 molal; and
(f) wherein the lithium salt is chlorine.

10. A non-aqueous electrolyte solution according to claim 1:
(a) wherein said first solvent is comprised of an ethylene carbonate and dimethyl ether mixture having a dielectric constant of greater than about thirty (30), a boiling point of greater than about two hundred (200) degrees Celsius, and a viscosity of greater than about 1.5 centipoises;
(b) wherein said second solvent is comprised of cyclic ethers, linear ethers having a molecular formula of CₘH₂ₘ₊₁OCₙH₂ₙ₊₁ wherein m and n are independently from 1 to 4, linear carbonates having a molecular formula of CₓH₂ₓ₊₁OC(O)OC_{y}H_{2y+1} wherein x and y are independently from 1 to 4, and mixtures thereof;
(c) further wherein said second solvent has viscosity of less than about 0.8 centipoises at twenty-five (25) degrees Celsius, a boiling point of less than about ninety (90) degrees Celsius, and a dielectric constant of less than about ten (10);
(d) wherein the ratio of the first solvent in said solvent mixture varies from about 10 percent to about 90 percent by volume;
(e) wherein the ratio of the second solvent in said solvent mixture varies from about 10 percent to about 90 percent by volume;
(f) wherein the concentration of said lithium salt is from about 0.1 molal to about 1.5 molal; and
(g) wherein the lithium salt is fluorine.

11. A non-aqueous electrolyte solution according to claim 1:
(a) wherein said first solvent is comprised of an ethylene carbonate and dimethyl ether mixture having a dielectric constant of greater than about thirty (30), a boiling point of greater than about two hundred (200) degrees Celsius, and a viscosity of greater than about 1.5 centipoises at about twenty-five (25) degrees Celsius;
(b) wherein said second solvent is comprised of cyclic ethers, linear ethers having a molecular formula of CₘH₂ₘ₊₁OCₙHₙ₊₁ wherein m and n are independently from 1 to 4, linear carbonates having a molecular formula of —CₓH₂ₓ₊₁OC(O)OC_{y}H_{2y+1} wherein x and y are independently from 1 to 4, and mixtures thereof;
(c) further wherein said second solvent has viscosity of less than about 0.8 centipoises at twenty-five (25) degrees Celsius, a boiling point of less than about ninety (90) degrees Celsius, and a dielectric constant of less than about ten (10);
(d) wherein the ratio of the first solvent in said solvent mixture varies from about 10 percent to about 90 percent by volume;
(e) wherein the ratio of the second solvent in said solvent mixture varies from about 10 percent to about 90 percent by volume;
(f) wherein the concentration of said lithium salt is from about 0.1 molal to about 1.5 molal; and
(g) wherein the lithium salt is bromine.

12. A metal/oxygen battery comprising:
(a) a lithium anode;
(b) an air cathode;
(c) a non-aqueous electrolyte solution wherein a lithium salt is selected from the group consisting of fluorine, chlorine, bromine and iodine and wherein the concentration of said lithium salt is from about 0.1 molal to about 1.5 molal;
(d) further wherein said non-aqueous electrolyte solution comprises a first solvent comprising an ethylene carbonate and dimethyl ether mixture having a dielectric constant of greater than about thirty (30), a boiling point of greater than about two hundred (200) degrees Celsius, and a viscosity of greater than about 1.5 centipoises at about twenty-five (25) degrees Celsius;
(e) wherein a second solvent is comprised of cyclic ethers, linear ethers having a molecular formula of CₘH₂ₘ₊₁OCₙH₂ₙ₊₁ wherein m and n are independently from 1 to 4; and
(f) further wherein said second solvent has viscosity of less than about 0.8 centipoises at twenty-five (25) degrees Celsius, a boiling point of less than about ninety (90) degrees Celsius, and a dielectric constant of less than about ten (10).

13. A metal/oxygen battery according to claim 12:
(a) wherein said non-aqueous electrolyte solution further comprises a lithium salt comprised of fluorine or chlorine and mixtures thereof.

14. A metal/oxygen battery according to claim 12:
(a) wherein said non-aqueous electrolyte solution further comprises a lithium salt comprised of fluorine.

15. A metal/oxygen battery according to claim 12:
(a) wherein said non-aqueous electrolyte solution further comprises a lithium salt comprised of chlorine.

16. A non-aqueous electrolyte solution comprising a lithium salt with a general molecular formula of LiBF₃X where X is selected from the group consisting of fluorine, chlorine, bromine, or iodine, and a solvent mixture according to claim 1:
(a) wherein the first solvent is comprised of gamma-butyrlactone.

17. A non-aqueous electrolyte solution comprising a lithium salt with a general molecular formula of LiBF₃X where X is selected from the group consisting of fluorine, chlorine, bromine, or iodine, and a solvent mixture according to claim 1:
(a) wherein the first solvent is comprised of N-methylpyrrolidinone.

18. A non-aqueous electrolyte solution comprising a lithium salt with a general molecular formula of LiBF₃X where X is selected from the group consisting of fluorine, chlorine, bromine, or iodine, and a solvent mixture according to claim 1:
(a) wherein the first solvent is comprised of tetramethylene sulfone.

19. A non-aqueous electrolyte solution comprising a lithium salt with a general molecular formula of LiBF₃X where X is selected from the group consisting of fluorine, chlorine, bromine, or iodine, and a solvent mixture according to claim 1:
(a) wherein the first solvent is comprised of triethylene glycol dimethyl ether.

20. A non-aqueous electrolyte solution comprising a lithium salt with a general molecular formula of LiBF₃X where X is selected from the group consisting of fluorine, chlorine, bromine, or iodine, and a solvent mixture according to claim 1:
(a) wherein the first solvent is comprised of tetraethylene glycol.

21. A non-aqueous electrolyte solution comprising a lithium salt with a general molecular formula of LiBF₃X where X is selected from the group consisting of fluorine, chlorine, bromine, or iodine, and a solvent mixture according to claim 1:
(a) wherein the concentration of said lithium salt is from about 0.5 to about 1.0 molal.
